(19) United States
(12) Patent Application Publication
(10) Pub. No.: US 2026/0072905 A1
(43) Pub. Date: Mar. 12, 2026

(54) UNDERSTANDING USER INTENT AND ENHANCING NAVIGATION OF DATA ANALYTICS THROUGH NATURAL LANGUAGE INTERFACES

(71) Applicant: Cerebri AI Inc., Austin, TX (US)

(72) Inventors: Jean Joseph Belanger, Austin, TX (US); Gabriel Mauricio Silberman, Austin, TX (US); Hongshi Li, Vancouver (CA); Nora Elsa Celis, Liberty Hill, TX (US); Oscar David Villarreal, Toronto (CA); Wemer Mercado Wee, Houston, TX (US); Radek Marik, Husinec-Rez (CZ); Uladzislau Yorsh, Prague (CZ); Steven Lincoln Harter, Virginia Beach, VA (US)

(21) Appl. No.: 19/326,097

(22) Filed: Sep. 11, 2025

Related U.S. Application Data
(60) Provisional application No. 63/693,657, filed on Sep. 11, 2024.

(51) Int. Cl. G06F 16/242; G06F 16/2457; G06F 16/248; G10L 15/183

(52) U.S. Cl. CPC G06F 16/243; G06F 16/24578; G06F 16/248; G10L 15/183

(57) ABSTRACT

Provided is a technique referred to as Voice to Analytics (“Vox2A”), an approach to produce analytic results from a collection of data by using natural language interrogation based on broad but constrained interpretation of user intent to create and present a set of responses containing the sought-after information. The result may be a faster “time-to-analytical answers” tool featuring a shorter user learning curve and easy to navigate experience, making for faster, more informative results, thus improving user productivity.

### CROSS-REFERENCE TO RELATED APPLICATIONS

This application claims the benefit of U.S. Provisional Pat. App. 63/6936,657, titled VOICE TO ANALYTICS, filed 11 Sep. 2024, the entire content of which is hereby incorporated by reference.

### BACKGROUND

### 1. Field

The present disclosure relates generally to artificial-intelligence and, more specifically, to techniques for handling ambiguity when using natural language for retrieving data by exploiting large language models while providing guidelines for answer integrity and reduction of hallucinations.

### 2. Description of the Related Art

Software systems generate large volumes of data relating both to system performance and user interactions. Organizations often use tools to collect, process, and analyze such data in order to derive actionable insights. Many software analytics platforms, such as user behavior analytics tools and system monitoring tools, provide mechanisms for capturing event data, aggregating metrics, and presenting results in visual or report form. For example, user behavior analytics tools may track feature usage, navigation paths, and retention rates, while system monitoring tools may measure response times, error frequencies, and resource utilization.

Such tools are useful because they enable data-driven decision making and improve system reliability. Product teams may identify workflows that result in user drop-off or features that drive engagement, thereby informing development priorities. Engineering teams may detect performance bottlenecks, identify anomalies, or predict potential system failures, thereby improving system stability and availability. Accordingly, software analytics tools address the need for improved visibility into both system performance and user behavior, allowing organizations to optimize functionality, reliability, and overall user experience.

### SUMMARY

The following is a non-exhaustive listing of some aspects of the present techniques. These and other aspects are described in the following disclosure.

Some aspects include a process, including: receiving, within a computer system, a natural language request that relates to data in a data store; selecting, within a computer system, among a subset of queries in a query language based on the natural language request; creating, within a computer system, a set of candidate results in response to the natural language request; determining, within a computer system, a confidence score for the set of candidate results; and presenting, within a computer system, at least some candidate results and their associated abbreviated information, based on the confidence score of each result.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a swim-lane diagram depicting an example process for providing data analytics in response to user input, in accordance with some embodiments.

FIG. 2 is an example diagram depicting presentation of a plurality of first level results to a user, in accordance with some embodiments.

FIG. 3 is an example diagram depicting presentation of second level results, with options for third level and deeper results, to a user, in accordance with some embodiments.

FIG. 4 is flowchart of a process for handling natural language ambiguity, in accordance with some embodiments.

FIG. 5 is a system block diagram of an example computing device by which the present techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of natural language processing and artificial intelligence. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Many analytics software tools involve tedious tasks when users are looking for information, examples including: clicking through a series of menus, setting up widgets or dashboard parameters, and establishing filters. While this approach may yield reliable results because of the constraints imposed by the menu structure, it often requires initial training and ongoing memorization of click sequences and appropriate answers to reach the desired information, which may negatively impact user productivity. None of which is to suggest that systems suffering from these issues are disclaimed or disavowed or that any other subject matter discussed herein is disclaimed or disavowed.

In some embodiments, large language models (“LLMs”) or other artificial intelligence (AI) models (e.g., small language models, rule-based AI, agentic models (which may be based on LLMs), etc.) may be used to streamline access to databases or other repositories, such as those with structured or unstructured data, by replacing (or augmenting) the click sequence noted above with a natural language request, be it oral or textual. In this scenario, in some embodiments, the LLM may take over communications with the Data Access Layer (“DAL”) and may dynamically construct and display the requested information. This, in some embodiments, may reduce the learning curve to quickly and precisely extract valuable information, which may facilitate efficient data exploration and provide new interface modalities, such as voice interface, to communicate with the analytics system. None of which is to suggest that all embodiments afford these benefits or that any other feature is required in all cases.

In some cases, along with improvements in data retrieval, the LLM or other model mediation may also introduce new challenges to overcome, such as inaccurate responses, which may be caused due to ambiguity found in some language constructs, their semantics, inadequate training data, lack of sufficient context, sarcasm and other emotional subtext, etc. These inaccuracies may cause violations of answer integrity, which may undermine the reliability needed for making decisions in a variety of contexts, including business, healthcare, security, etc. Furthermore, striving to produce a single, correct, and detailed answer to an unrestricted query may also tax computing resources and result in unacceptable latency in the response.

Some methods to address answer ambiguity include the use of single- and multiple-turn conversations to elicit information from the user or by presenting sets of alternatives for selection to the user. In some cases, this approach may narrow the focus of the query to determine a user's precise intent, but although this approach may be more user-friendly than a sequence of clicks, it may still be relatively inefficient.

Some embodiments implement a technique for natural language mediated data analytics, referred to herein as “Vox2A.” In some embodiments, Vox2A may be expected to increase the likelihood that a desired response (e.g., what the user is really asking for) is included among a set of results (e.g., dashboards, widgets, calculations) shown to the user or at a location chosen by the user (e.g., in a client computing device, displaying in a browser (or native app), in communication via the internet with a server hosting a multi-tenant software as a service application instructing the browser what to show and having data interrogated by input to the browser, etc.), without any need for the user to provide additional information beyond the initial query (e.g., interrogation).

Some embodiments may combine elements from these two methods to create a reliable computing architecture for information extraction and presentation, which may operate without taxing either the user or computational resources. Some embodiments do so by taking broad view of the possible user intent to create a set of responses (e.g., which represent likely interpretations of the user's query) and present them so the user may choose the sought-after knowledge. Also, some embodiments may leverage a variety of techniques, including machine-learning (ML), retrieval-augmented generation (RAG), domain-specific dictionaries, tracking user actions, learning from user actions, etc., including with the manner of response presentation (e.g., the showing of a set of responses) to enhance the probability of the correct knowledge (e.g., that actually wanted by the user) being present among those responses depicted to the user.

Furthermore, in some embodiments, the effective creation of guardrails may keep the dialog (e.g., the user dialog, any response dialog requesting clarification, etc.) within a known dictionary of interrogations. In some embodiments, this may allow Vox2A to recognize (e.g., recognize quickly) when the information requested cannot be fulfilled by available data or computational capabilities, and may reduce answer latency and computation time, along with user frustration.

In some embodiments, additional advantages may be provided by restricting the space through guardrails. For example, by providing guardrails on allowable queries, one may avoid converting natural language directly to data queries, such as by using SQL or another database query vehicle, which may be unreliable (for example, which may create queries which over simplify ambiguities, point to the wrong tables, etc.). In another example, providing guardrails on allowable queries may prevent so-called “hallucinations”, which may be patently untrue results produced by some LLMs, including in response to an unanswerable question, whose creation is yet to be fully understood. None of which is to suggest that all embodiments afford these aforementioned benefits or that any other feature is required in all cases.

In the following sections, some embodiments are described. Then an example process for parsing a user request and complementing visual responses, including with spoken descriptions, to enhance user comprehension of the results Vox2A is presented.

Some example opportunities for acquiring knowledge throughout the life of a deployed system are then described. These techniques may, in some embodiments, be used to generate accurate, up-to-date, and contextually relevant responses by incorporating new information and tracking user actions. The various types of guardrails are then discussed. To conclude, some features and advantages of some embodiments are described.

### Context and Contrast

Some embodiments may use a natural language interface for an analytics platform, be it voice or text. In some embodiments, the natural language interface may include visuals, such as sign language processing (SLP), emotional detect (such as provided by vision-language models), etc. In some embodiments, the natural language interface may include sentiment analysis, including as input in a feedback component. Some embodiments may pass text through various LLMs, including Llama3, GPT4, Gemini, Claude3 (Meta, 2024; OpenAI, 2023; Google DeepMind, 2024; Anthropic, 2024), which may be publicly available as chatbot or other relatively insecure offerings. Some embodiments may bridge an opensource (or other non-secure) frontend with potentially proprietary data in the backend, including by anonymizing query generation submitted to the front end while allowing generated prompts (such as SQL commands) to operate on databases, where the data itself may not be available to the LLM. Some embodiments may explore direct generation of database queries, such as using SQL, from natural language input.

In some embodiments, however, this approach may present certain challenges. For example, the differences between human language, which is a fluid, ambiguous, and context-dependent natural language, and SQL, which is a precise and structured language, may create difficulties in translation between the two. The model, in some embodiments, may need to have knowledge about the structure of the database, the data types, the relationships between tables, etc. (e.g., about data which may be proprietary or otherwise protected). In addition, for some business task with specific terminology, it may be helpful to train the model on how to translate specific business terms into data structure(s) applicable to respective database(s) or to understand business needs, e.g., business needs in general (for example, that documented expenses may be submitted as reimbursements and lag behind incurred expenses, that there is both a Paris, France and a Paris, Texas, etc.), business needs specifically (e.g., that expense reports are run on the 10th of the month or the Monday after the 10th if the 10th is over a weekend, that employees are likely to fly to Paris, France, but unlikely to fly to Paris, Texas, etc.), such as to be able to chat with the user by presenting an approximation of a proper understanding of the problem in order to answer their questions effectively. However, even with training, such a model may fail to take full advantage of the database, as users may not be aware of all the attributes available in the data which can serve to identify and retrieve a set of desired records and present them as an analytics result. For example, a user may be unaware that flight records are stored with information about which project generated an expense, leading to a query “How much was spent on flights to Geneva?” when he really meant “How much was spent traveling to Geneva for Project X?”, where the actual query used may include both unwanted results (an amount spent flying to Geneva for other projects) and fail to include wanted results (amounts spent on alternative transportation methods for Geneva).

To alleviate this problem, in some embodiments, a chatbot may be provided to ask the user clarifying questions or present options for selection, which may be produced according to the needs for creating, for example, an SQL query reflecting the user intent. This, in some embodiments, may be done in a single question-answer cycle, a so called “single-turn” conversation, or using several exchanges which may produce a richer dialog, referred to as a “multiple-turn” or “multi-turn” conversation. In order to yield the accuracy preferred by an enterprise or in other critical decision-making scenarios contexts, in some embodiments, the dialog may be verbose or the number of turns extensive and therefore not conducive to a productive user experience.

Some embodiments are designed to use spoken natural language but also be usable with text/pointing input, touchscreen input, visual input, etc. Some embodiments are designed to constrain the space to a preselected target list of numerical outputs, graphic widgets, or dashboards. For example, a predetermined number of outputs (e.g., more than one, less than five, etc.), a predetermined type of presentation (e.g., list, pie chart, etc., which may include click through drill down into the data), a predetermined set of results (e.g., results useful in determining expense reports, results useful for an enterprise travel agent, etc.). In order to produce these results or, in some embodiments, from operations on these results, one or more queries may be run against a single or multiple databases (or other data stores). In some embodiments, these queries may be fully defined and may, therefore, be guaranteed to (or more likely to) present accurate information than queries which are created dynamically directly from a natural language request. Some embodiments may replace (or augment) the dynamic creation of database queries with well-defined calls to predefined routines, for example using a JSON (JavaScript object notation) representation.

In some embodiments, many semantically equivalent questions may be provided (such as by generation with the help of LLMs, including by reverse-engineering the code to generate results, or by a manual process) which may be matched to a natural language request. A natural language request may be matched to an appropriate query (for example, a SQL query) by tagging keywords present in the natural language request and comparing them to keywords associated with predetermined database queries. In some embodiments, the selection process of a database query for a natural language request may create a set of candidate results, where the set may contain a single result, multiple results, or be empty. In some embodiments, in the case of a single result, the single result may be presented to the user as the desired answer. In some embodiments, a confidence score may be used to determine if the result is presented with conviction, e.g., “this is the information you requested”, or in a more nuanced manner, e.g., “this may be the information you requested”, such as by comparing the confidence score to respective thresholds.

Some embodiments may deal with a set of candidate results containing multiple answers—e.g., the request mapped to several results—by presenting the user several of the results of the set (e.g., selected by ranked confidence score) in abbreviated form—e.g. as a textual statement describing the target results and possibly its tags (for example, “expenses year to date”, “expenses month to date”, “expenses by employee”, etc. In some embodiments, if the set of candidate results contains multiple answers, only some of the results may be presented, such as those which have a confidence score above a threshold, which may be a different threshold than used for confidence scores in the single candidate result case. By clicking or otherwise selecting one of multiple results presented, the user, in some embodiments, may gain access to more detailed information, if available.

In some embodiments, an empty set of possible responses may correspond to an out-of-bound or otherwise improper request. In some cases, it may be possible to determine the reason for the boundary violation. For example, this may be the case when additional information is needed to properly respond to a request. An instance of this case may be the request “compare my travel spend to sector peers”, since the system may not have access to such information about sector peers.

The properties of three example approaches to database querying with natural language processing may be summarized as follows. First, the three approaches may be single-turn conversations used to convert a natural language (“NL”) request to structured query language (“SQL”) queries (“NL to SQL”), multiple-turn conversations to convert a NL request to SQL queries (or another structured or unstructured database query language or type), and an embodiment, e.g., of Vox2A, to proceed from a NL request to the visualization of one or more results (“NL to Dynamic Dashboard Generation”, or “DDGen”), where corresponding SQL queries are already defined and verified. The properties of each approach may be used to discern their capabilities to handle various natural language requests, which may include user intent detection, answer integrity assurance, constraints to avoid out-of-bound questions, handling of ambiguity, anticipation of additional requests, and computational cost effectiveness. None of which is to suggest that all embodiments afford these aforementioned benefits or that any other feature is required in all cases. Direct conversion, whether single-turn or multi-turn, of a natural language request to a SQL query may not detect user intent, provide answer integrity, constrain out-of-context questions, provide alternative responses to ambiguous questions, anticipate follow up questions, or provide cost-effective leverage of LLM access. Single-turn direct conversion may provide improved user interaction over multiple-turn direct conversion, in that users may generally prefer fewer turns and direct provision of answers in response to their requests, but multi-turn conversions may provide more accurate queries, especially in the case of ambiguous natural language requests. However, DDGen may provide improvement over direct SQL conversion, especially for SQL queries which are already defined and verified, such as user intent detection, answer integrity guarantee (e.g., versus hallucinations), constraint against out-of-bounds questions, provision of alternative responses to ambiguous questions, including by refining questions to conform to guardrails, anticipation of follow-up questions, including common or previous follow-up questions, and cost-effective use of an LLM (e.g., versus indiscriminate prompt or input generation and operation).

### Examples of the Vox2A Approach

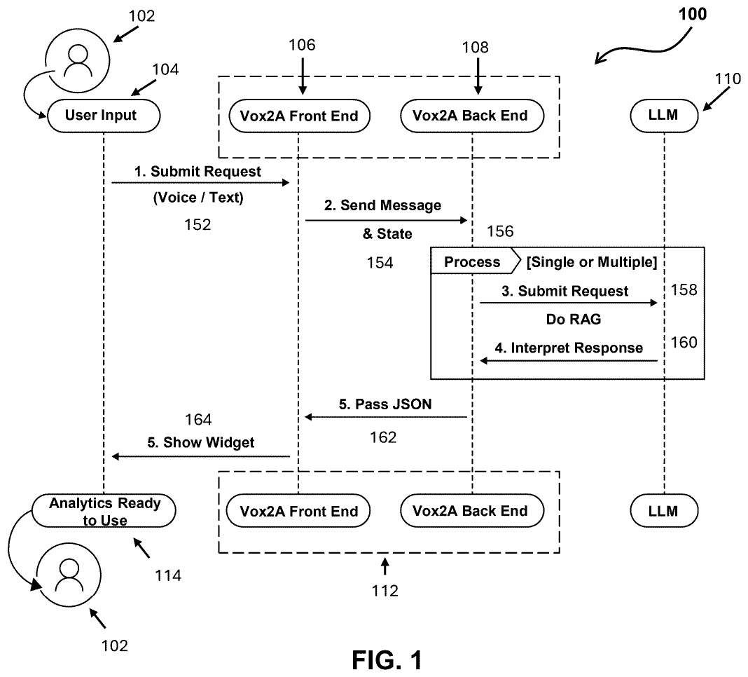

FIG. 1 is a schematic diagram depicting an example process 100 for providing data analytics in response to user input, in accordance with some embodiments. FIG. 1 depicts a user 102, who provides user input 104 to the example process. The user input 104 may be any appropriate user input, such as live voice or other sound data, voice recording, text input, visual input, such as video, photo, etc. The user input 104 may be submitted as a request (at operation 152) to Vox2A frontend 106, where the request may be submitted in any appropriate format and through an appropriate input device (e.g., a text box, such as in a browser or dedicated data-query application, a microphone, a video camera, etc.). The Vox2A frontend 106 may then process the request to identify one or more message and state for Vox2A backend 108 (such as at operation 154). The Vox2A frontend 106 and Vox2A backend 108 may be part of the Vox2A system 112, including sub-systems, or independent systems described here as related. The Vox2A backend 108 may operate on the identified message and state to generate one or more requests to an LLM 110. The exchange between the LLM 110 and the Vox2A backend 108 may occur in a process 156 where one or more requests, including concurrent, subsequent, co-pending, iterative etc. requests, may be sent from the Vox2A backend 108 to the LLM 110 and one or more responses from the LLM 110 received by the Vox2A backend 108 in return. The requests sent to the LLM 110 may be in any appropriate language, including natural language. They may be requests for queries (e.g., queries to a database) in any appropriate format, such as in SQL query language. In some embodiments, a NL request provided by the user 102 may be associated with a predetermined request to be submitted to the LLM 110. The requests submitted to the LLM 110 may be novel requests, e.g., request which have not previously been sent to the LLM 110 for conversion to query language (such as in SQL format). The LLM 110 may be any appropriate model, including an open source LLM, chatbot, or agentic model. The LLM 110 may be a proprietary model, including a proprietary instance of an open source or other non-proprietary model. The LLM 110 may be a foundational model. The LLM 110 may operate on any appropriate input, including a single input, multiple inputs (including prompts, contextual inputs, etc.), tokenized data, unstructured text, structured input, voice or other audio, visual, text, etc. The LLM 110 may instead be another type of model, such as a small-language model, rule-based model, etc. The LLM 110 may then send a response, such as in the process 156 back to the Vox2A backend 108. The LLM 110 may output any appropriate response, which may be a SQL query, a direct answer to the NL request of the user, or any intermediate step in converting a NL request into a data analysis answer to the NL request. The LLM 110 response may then be interpreted by the Vox2A 108 backend.

Interpretation may include creation of a JavaScript Object Notation (JSON) or other appropriate data structure for generation of data in a format usable by the user 102. In some embodiments, the LLM 110 or another model (for example, a proprietary model) may perform additional operations, such as RAG or another data-augmented process based on the response of the LLM 110. For example, the LLM 110 may output SQL command for data retrieval from a database, but not have enough knowledge about a specific database to complete the command. In this example, the LLM 110 may perform RAG based on a supplied terminology dictionary, database addressing system, or other information in order to complete or correct the SQL command such that the correct data is located. The Vox2A backend 108 may then pass the JSON object (e.g., at operation 162) to the Vox2A frontend 106, which may operate on one or more data store of the enterprise to generate data (such as by generating a widget (or chart(s), graph(s), list(s), which may or may not be clickable including clickable through to other levels of data display) at operation 164) to display to the user 102.

To further illustrate the Vox2A approach, which in some embodiments may be an instance of a DDGen solution, a non-limiting example, which is not to say that any other examples are limiting, based on the request “show top travelers” directed at an analytics platform containing business travel information is discussed hereafter. A dialog-based approach may, in some embodiments, request additional information, such as metrics for selection (e.g., amount spent, number of trips, or days on the road), and other criteria such as the period (e.g., this month, this quarter, or year-to-date), or the number of top travelers to display, while a system based on presenting alternatives may instead or additionally show these and ask the user to select among them.

Vox2A, instead or in addition, in some embodiments, may output a set of responses with abbreviated information. For example, Vox2A may output, for the above example, a plurality of lists (e.g., three, or some other number, like 5 or less than 10 or less than 7), each with the top five names according to a given criterion (e.g., the amount spent, number of trips, and days on the road) for this month, and relevant numeric values (e.g., the amount spent).

In some embodiments, upon user selection of a list, an expanded view with additional list entries may be displayed, where each additional entry may be expanded to contain further information, such as the traveler's department, role, and a breakdown of their spending, policy compliance, their ranking according to other criteria, etc. The new view may, in some embodiments, also contain a graphic covering the selected metric for different relevant epochs, such as current month, current quarter, last quarter, and year-to-date, and may include a comparison to similar periods for the previous year(s).

In some embodiments, this approach may provide an enhanced user experience. For example, if a user selects the list ranking by amount spent, access to the list by number of trips may be directly available through a traveler's ranking by the latter criterion.

Also, it may be possible to prepare responses, in some embodiments, to anticipated follow-up questions in the form of selectable (such as by clicking, text or voice command) icons and text. For the travel example above, these “1-click away” or “next-level” responses could include, for instance, top destinations (by country, state, province, city, etc.), top airlines and hotel properties (by travelers, departments, etc.), travel completed vs. travel booked or in progress (e.g., accrued).

In some embodiments, some or all of the Vox2A process may include training a model based on past behavior (e.g., user behavior), which may include a feedback process. For example, in some embodiments, Vox2A may be given the capacity to learn, such as over time, the intent of an individual user (or cohort of users) including what a user prefers to see (e.g., what that user usually selects to drill down to in the data, what final data the user views (e.g., where the user may keep trying new commands until they receive the data they are looking for), what the user means when using specific expressions, etc. In some embodiments, a short learning curve, such as facilitated by machine learning based on a user's past behavior, and an easy to navigate experience, such that there is no need to find or remember the path of clicks to reach a dashboard, may improve user experience.

Also, in some embodiments, additional relevant information may be just a click (or voice command) away, such as in a next level data display, which may make for a more productive, accurate, and more responsive system.

These are just some of the features accessible directly from various embodiments of an example Vox2A spoken interface, which may offer a clear user productivity advantage over text/point interfaces, which is not to say that Vox2A may not also offer these advantages in embodiments without spoken interfaces.

### Parsing User Requests

Voice input, in some embodiments, may improve productivity through hands-free interfacing and efficient input, while facilitating a more natural and intuitive work flow through dashboards rather than typing. As such, voice input may be used as the input method for Vox2A, using, in some embodiments, a speech-to-text step for approximately all spoken requests (e.g., questions, navigation commands, etc.).

Additionally, speech-to-text technology, in some embodiments, may enhance accessibility, such as by providing individuals with disabilities or those unable to use some other input methods with an efficient means to engage with digital systems. In some embodiments, this convergence of convenience and inclusivity may make Vox2Aa desirable addition or replacement to any system relying on a conversational interface.

Some suitable speech-to-text models may be accessed via the Internet as a service, such as via an application programming interface (“API”), while others may be executed locally. Some of these services, in some embodiments, may provide customization options, which may include pre-trained models for accuracy and intent detection. Different speech-to-text models may have different cost-accuracy tradeoffs, keyword detection abilities, fine-tuning options, and developer-accessible consoles (which may include command outputs such as in various programming languages).

Some embodiments may obtain a user's natural language request in text format, such as from a speech-to-text service or application, and then transform the user's request(s) into visual data representation(s), such as charts, graphs, and plots which may implement spoken commands. This may be done with Vox2A in coordination with graphical generation tools.

Some embodiments may help users to create informative and insightful visualization, without requiring users to have any specialized knowledge in the visualization techniques of the dashboarding tool, such as the file format or specification requirements for generating the interface components (widgets).

In some embodiments, Vox2A may leverage LLMs to interpret and understand the user request, extracting the relevant features and determining the appropriate type of visualization. Some techniques to enhance the performance and accuracy of this process may include:
a. Prompt Engineering:
   i. In some embodiments, this may involve designing prompts to guide the LLM to produce the desired output. By providing clear instructions, context, and examples within the prompt, along with the user's natural language query or a query associated with the user's natural language query, this technique may help ensure that the request and intent is interpreted accurately, and that the correct visualization is generated using the appropriate dashboard specifications.
b. Retrieval-Augmented Generation (“RAG”):
   i. In some embodiments, by incorporating a retrieval mechanism that may access knowledge sources or databases, which may be proprietary, have domain specific lexicography, etc., RAG may improve the ability of LLMs to contextually constrain potentially very detailed domain- and entity-specific knowledge, as well as provide up-to-date information (e.g., information generated after a training data of the LLM), to fit efficiently in the LLM prompt.
   ii. In some embodiments, RAG may be used to dynamically fetch relevant documentation or schema, visualization templates, and previous user requests and results, which may help improve the model's accuracy in generating meaningful visualizations and which may improve user-specific performance.
c. Fine Tuning:
   i. In some embodiments, fine tuning may involve training a foundational LLM (or upstream or downstream model or subset thereof) on a specific dataset related to expected tasks, which may allow the model to learn company and industry nuances or domain knowledge. By fine tuning an LLM on datasets containing natural language user requests and corresponding data visualization specifications, in some embodiments, the model's performance may be improved while potentially maintaining the same latency as found when using a foundational LLM.

By using these techniques, some embodiments may result in an increase in the ability of LLMs to parse user queries into the specification the dashboard requires, making it easier for users to interact with their data without needing specialized knowledge or training. Furthermore, in some embodiments, supplemental technologies, such as Continual Learning, may be brought to bear upon deployment of Vox2A.

### User Interface

The use of voice to request information and navigate a system may open an array of opportunities to enhance user productivity, which may include faster interactions and abbreviated navigation. (Though non-voice interfaces are also contemplated.) In some embodiments, the use of voice as output from the system to the user may further be used, whether by itself or in combination with visual information and cognitive clues for improved user comprehension.

Voice output in Vox2A, in some embodiments, may include explanation and clarification in spoken natural language to complement a presented data visualization. This, in some embodiments, may facilitate comprehension, analogous to using voice-over with a slide presentation or video, and may serve as reassurance (e.g., to the user) that the spoken request was correctly understood.

For example, if a user asks, “Who are my top vendors?”, Vox2A may, in some embodiments, make one or more assumptions to answer the question, for example, such as ranking vendors regardless of spend category, using current year-to-date data, and showing the top ten vendors.

In some embodiments, when presenting the data, Vox2A may also present which constraints were used to generate the data. For example, Vox2A may clearly state (e.g., in spoken voice) what assumptions were made, in addition to presenting the chart listing the top travelers. That is, the spoken output may say “Here are the top ten vendors, year-to-date, across all spend categories,” which is not to say that visual (e.g., textual) assumption listings are in any way disclaimed.

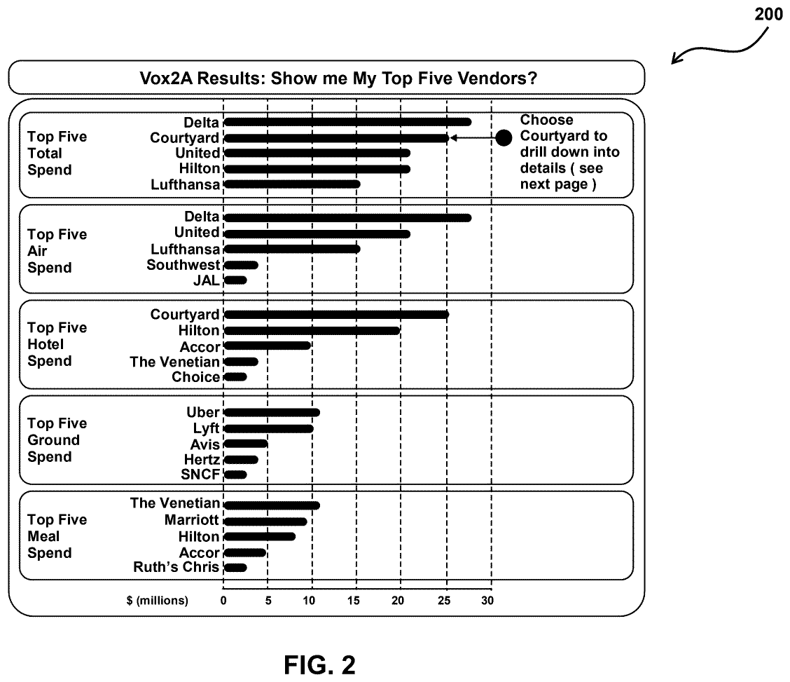

FIG. 2 is an example diagram 200 depicting presentation of a plurality of first level results to a user. FIG. 2 depicts an example embodiment, in which assumptions are made in order to answer a natural language questions and ways in which the variation in answers to the questions based on those assumptions may be depicted. For example, in some embodiments, when using a single-turn conversation (e.g., where only one exchange takes place between the user and Vox2A) a plurality of results may be presented, as shown in FIG. 2.

These plurality of results, in some embodiments, may be created under different set(s) of assumptions. For example, in FIG. 2, the natural language request “Show me my top five vendors” generates both a ranking of total spending with vendors of different categories and multiple ranking separated by categories (e.g., air, hotel, ground, and meals). By providing a top-level answer and additional possible answers (for example, the categorical answers), Vox2A may increase the likelihood that the desired information is within the user's immediate reach. In some embodiments, a voice output may then instruct the user to “Select the main result for further details, or another alternative for a different perspective” or another appropriate description of click-through results.

In some embodiments, even if there is only a single chart or other result being displayed, Vox2A may provide a voice output, such as paraphrasing its title, providing a short explanation, or even drawing the attention to a salient feature (e.g., “Air spending was higher than normal this month”), which may the user experience and facilitates comprehension.

In some embodiments, a voice result feature may be generated by sending an additional prompt to an LLM (e.g., the same or a different LLM) after Vox2A prepares the data summary. In this prompt, in some embodiments, the LLM may act as an active listener and compare the user's request with the prepared data summary and providing clarifications (e.g., to the prepared data summary) within the context of the user's question.

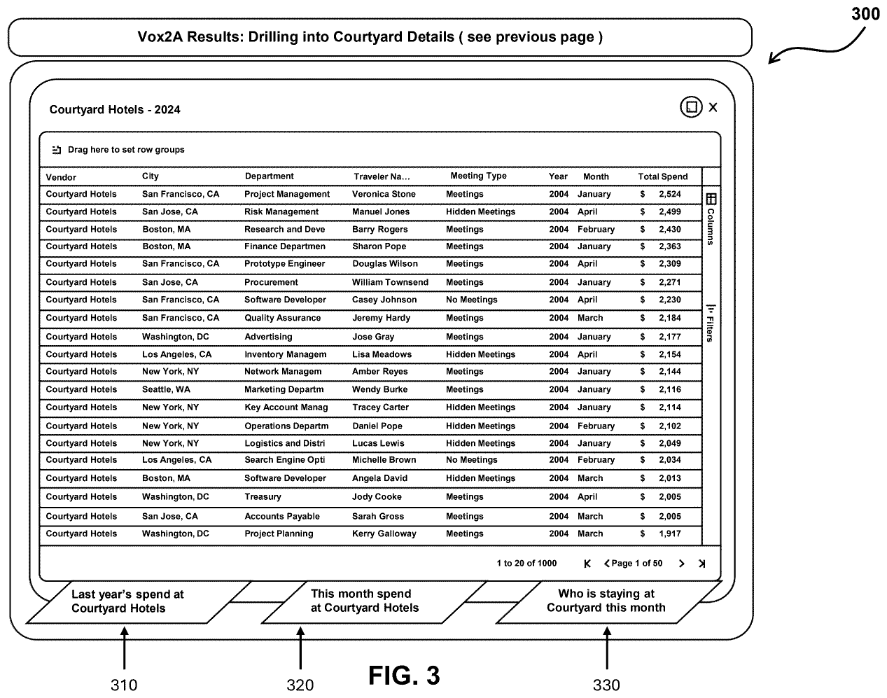

In some embodiments, additional techniques may be used to improve the user experience, and to track user actions, such as the use of “1-click away” (or next level) precomputed results, which may be used to anticipate follow-up questions, as shown in FIG. 3.

FIG. 3 is an example diagram 300 depicting presentation of second level results, with options for third level and deeper results, to a user, in accordance with some embodiments. In FIG. 3, example output is present for 1-click away using a travel example. For example, from FIG. 2, a user clicking on “Courtyard” in the top five total spend, may be displayed the diagram 300 of FIG. 3, which shows the details of the “Courtyard” spend, including vendor (e.g., Courtyard), city, department, traveler name, meeting type, year, month, total spend, etc. Additionally, in diagram 300, bottom boxes 310, 320, and 330 represent links to data displaying answers to possible follow-up questions that user may pursue (e.g., “last year's spend at Courtyard Hotels” in box 310, “this month's spend at Courtyard Hotels” in box 320, and “who is staying at Courtyard this month” in box 330). When user clicks on any of those boxes, depending on selection, a specific amount or an expanded view with additional information is displayed as a “2-click away” or second level drill down from the original natural language question.

In some embodiments, displaying multiple results may enable Vox2A to hedge its bets about what data the user really wants. For example, an initial attempt may be made based on a set of assumptions, and the assumptions refined over time based on user behavior, such that it appears that Vox2A, in some embodiments, is able to intuitively suggest additional insights to complement an original request. In some embodiments, providing additional results may serve as an invitation to the user to further explore the data and expand their information discovery and possibly gain new insights into the data and interrelatedness.

In some embodiments, voice commands, and Vox2A feedback may be used to navigate between dashboards and to select various options to create or modify what information is being shown and how. For example, “display as a pie chart” may change a total spend listing in a table, to a pie chart representation of each individual item's share to the total spend. These options, which may be already available through a point-and-click modality, may be possible to implement via voice input. Voice input may include, in some embodiments, the ability to select individual display element to drill down, to filter data by selecting specific properties, to change visualization modalities, etc. For example, from a table showing the top ten travelers in an organization a drill down may show trip details for a selected traveler, applying a filter may show the top ten travelers in two specific departments, and a different visualization modality may show the relative spend of each traveler in a bar chart.

### Continual Learning

Generative AI models, in some embodiments, may be frozen in time and unable to adapt to new information. In some embodiments, models may be updated to include additional information, e.g., information created after their training, by techniques such as Retrieval-Augmented Generation (RAG), Continual Learning (CL), etc. RAG, in some embodiments, may improve the LLMs capability to generate accurate and contextually relevant responses (such as previously described). Continual Learning may describe a process by which a model may be built and trained incrementally and dynamically updated across its lifetime, while retaining knowledge of previous training and tasks. Some embodiments may implement CL by using a generative feedback loop, or closed-loop learning (examples of which are described below in Shorten, C., 2023; C3AI, 2024, the contents of which are hereby incorporated by reference). A feedback loop, in some embodiments, may use RAG to allow the system to learn and improve over time by harnessing the system's response and the actions of end users to expand the knowledge base for future use.

During the deployment phase, in some embodiments, feedback loops may help AI models become more accurate by identifying anomalies in their output and feeding information about such anomalies (e.g., that a hallucination was generated, that the user wanted information B and not information A, etc.) back into the model as input. Agentic workflow may also be used to apply a continuous refinement. For example, the feedback mechanisms may allow AI agents to learn from the outcomes of their actions (e.g., such as by requesting user rating). Such implementation, in some embodiments, may help the system to offer increasingly accurate and relevant insights without requiring a complete reset or retraining every time new data is added. At least three scenarios that may benefit from applying Continual Learning are described below, which is not to say that CL may not help in other scenarios:
a. New or Ambiguous Question Resolution:
   i. In order to resolve ambiguous requests (which may include new request that the system has not processed before), Vox2A, in some embodiments, may display a set of results and ask the user to choose the set of results with the desired information (see e.g., FIG. 2). This, in some embodiments, may create the equivalent of a single-turn conversation to determine intent, but instead of asking for clarification (which the user may find cumbersome), the user may simply select one of the results (which may already be prepared). In this way, the user may select the sought response and Vox2A, in some embodiments, may learn how the new or ambiguous question might have been solved, and may operate on such user feedback as new knowledge.
b. Tracking User Actions:
   i. In order to learn which results are desired, Vox2A in some embodiments, may track user movement through the data. For example, if the top response presented as output is not the desired one, in some embodiments, users may effectively change the output by selecting a different response from the list of multiple results provided (see e.g., FIG. 2). In some embodiments, such selection may be used to learn user preferences for future recommendations. Likewise, some embodiments may have a feedback loop in which the user may rate the relevance and usefulness of the responses, such by pressing a thumbs-up or thumbs-down button.
c. Intuitive follow-up Questions:
   i. In order to provide deeper data analytics, it may be possible to in some embodiments, to prepare (e.g., prepare with the presented data answering a user's request) a list of follow-up questions, including together with their responses, in order to provoke a user's curiosity to discover more facts, seek new information, and explore data to gain insights into past trends, predict future behaviors, stay ahead of the competition, etc. An agent may be trained, in some embodiments, as an expert travel analytics assistant, such as trained to anticipate some of the user questions based on the dashboard options and previous user questions (e.g., by tracking), such as to make their experience more engaging and effective.

### Guardrails

In order to ensure data security, integrity, and accurate results, some embodiments may implement one or more of several types of guardrails:
a. Access Control Guardrails: may ensure users only have access to information they are authorized to view, including based on a user profile.
b. Query Guardrails: may prevent users from abusing or (accidentally) overloading the system, including by limiting number of queries, time between queries, number of results per query, etc.
c. Output Control Guardrails: may prevent hallucinations or inaccurate results.
d. Privacy and Compliance Guardrails: may ensure the tool complies with legal regulations and corporate policies.

Some embodiments may implement guardrails as follows:
a. Provide an Audit Trail: may ensure full transparency of how results are obtained, including by identifying data sources and logging executed queries.
b. Direct Numeric Results from Databases: may ensure all numeric results come directly from database queries, not from LLMs.
c. User Feedback Mechanism: may allow users to provide feedback, such as on the accuracy, usefulness, timeliness, etc. of responses, and may use this feedback to improve the system.

These measures may, in some embodiments, may help enhance the reliability and trustworthiness of Vox2A.

Some embodiments afford a rich natural language spoken interface to sophisticated analytical functions, while preserving answer integrity.

As noted, some embodiments may replace the dynamic creation of database queries with well-defined calls to predefined routines, which may include taking a broader view of the possible user intent in order to create a set of responses and present them to the user for selection. Some embodiments may be designed to use spoken or text natural language inputs or pointing inputs and to constrain the space to a preselected target list of numerical outputs, graphic widgets, or dashboards. Using guardrails, some embodiments may keep the dialogue within a known dictionary of interrogations, which may allow the method to recognize when the information requested cannot be fulfilled by available data or computing capabilities or is restricted in another way, such as forbidden to a given user. By providing many equivalent questions which match a natural language request, such as by tagging the various types of results with keywords, the selection process of some embodiments may create a set of candidate results with an associated confidence score that determines how and in what order the results are presented. Some embodiments may then output a set of responses with abbreviated information that, when selected, presents the user with an expanded view of the data containing more information. In some embodiments, in addition to presenting the data, voice as output from the system to the user may provide an explanation and clarification in spoken natural language, including by using the generated tags, to complement the data summaries the user requested and to clearly state what assumptions were made. Based on the dashboard options and previous user questions, it may also be possible for some embodiments to prepare anticipated follow-up questions that suggest additional insights to complement the original request.

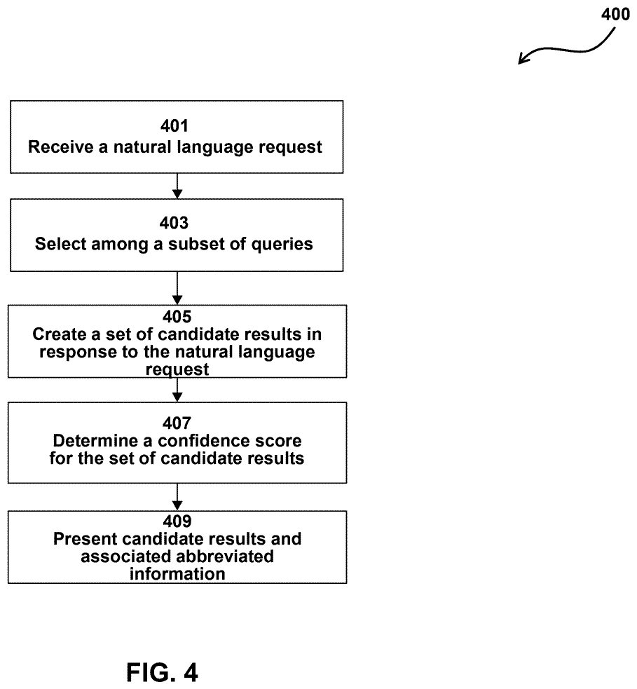

FIG. 4 illustrates an example flow-chart of a process 400 for handling natural language ambiguity in accordance with the present techniques. Embodiments of the example process 400 may be performed by a computing system, such as a computing system implementing a natural language processing service in accordance with the techniques described herein.

In some embodiments, the process includes receiving 401 a natural language request through a user interface, to produce analytic results from a collection of data. For example, the system may receive a request to “show top travelers” directed at an analytics platform containing business travel information. A natural language processing service may, for example, determine whether the request was made through a spoken or text natural language input or pointed input. In some examples, if the natural language request was made through spoken input, the natural language processing service may then need to convert the spoken input to text input for processing, through a speech-to-text step. In another example, if the natural language request is made by text or pointed input, the natural language processing service may then begin the process of transforming the request into visual data representations, through a text-to-text step.

In some embodiments, the process includes selecting 403 among a subset of queries. In some examples, the natural language processing service may need to determine if the request is within a known dictionary of interrogations using guardrails. This known dictionary, for example, may include a preselected target list of numerical outputs, graphic widgets, or dashboards. In some examples, the guardrails implemented by the natural language processing system may include access control guardrails, query guardrails, output control guardrails, privacy and compliance guardrails, audit trail guardrails, numeric result guardrails, and user feedback guardrails.

In the case that the request cannot be fulfilled, and a guardrail is violated, the processing service may, for example, respond with a boundary violation message. After determining whether the request is within the bounds of the natural language processing service, the natural language request may be parsed to determine key features of the request. In some embodiments, parsing the natural language request comprises extracting relevant features from the request to determine the appropriate type of visualization.

In some embodiments, after determining key features of the request, a second set of candidate results may be precomputed to anticipate follow-up questions. These precomputed results, for example, may be based on available data dimensions and are redefined over time using behavior to suggest additional insights to complement the original natural language request. After one of the candidate results from the first set of candidate results is chosen, the second set of candidate results are presented along with the additional information about the candidate result that was chosen. In some embodiments, these key features are then used to select from the subset of queries. The subset of queries, for example, are defined and verified prior to the selection process. The queries may be run against a single or multiple databases to determine which queries are to be selected for use in responding to the natural language request.

In some embodiments, the process includes creating 405 a set of candidate results in response to the natural language request. In some embodiments, the natural language processing service may map the natural language request to one, several, or no results that contain one or more key features extracted from the request. For example, by providing many equivalent questions to match a natural language request, as well as tagging the various types of results with keywords, the selection process creates a set of candidate results. Embodiments of the process may include creating a set of a single, multiple, or empty responses. For example, if the set of candidate results includes only a single result, it may be presented to the user as a single desired answer. In another example, if the natural language request was mapped to several results, the set of candidate results may contain multiple results. In this case, several of the results may be presented in abbreviated form. The abbreviated form, for example, may consist of a textual statement describing the target results and may describe associated tags. By selecting one of the results in abbreviated form, more detailed information about the result may be presented along with potential follow-up questions related to the result, if available. In another example, if the set of candidate results is empty, the natural language request may be an out-of-bound request as determined by the previous guardrails. A boundary violation may, for example, have been presented because additional information from the original natural language request may have been needed to properly generate an accurate response.

In some embodiments, the process includes determining 407 a confidence score for the set of candidate results. The confidence score may be determined based on how accurately the natural language processing service believes the candidate result to be in responding to the given natural language request. A candidate result with a higher confidence score may correspond to a result that includes a greater number of the key features that were extracted from the original natural language request. Further, a candidate result with a lower confidence score may correspond to a result that includes a smaller number of key features extracted from the original natural language request, which is not to say that the result would not be an accurate response to the original request. The confidence score may, for example, determine how the result is presented, and in which order the results are listed. For example, if the set of candidate results includes only one result, the confidence score may determine if the result is presented with conviction, i.e., “this is the information you requested”, or in a more nuanced manner, e.g., “this may be the information you requested”. In another example, if the set of candidate results includes multiple results, the confidence score may determine what order the results are presented in, with the candidate result corresponding to the highest confidence score being listed first.

In some embodiments, the process includes presenting 409 the candidate results and associated abbreviated information. The candidate results may either be a set of single, multiple, or empty responses. If, for example, the set of candidate results contains only a single result, only one result may be presented as the sole response to the natural language request. If, in another example, the set of candidate results contains multiple results, the results may be presented in order of their associated confidence score, with the result associated with the highest confidence score being listed first and the rest of the results listed in descending order based on their confidence score. If, in another example, the set of candidate results is an empty response, a boundary violation response may be presented. In this case, the natural language request may, for example, not have been within the scope of predefined queries or more information about the requested information may need to be provided for the response to be within the guardrails of the processing service. In the case of the sets of candidate results with a single and multiple results, each of the candidate results may be presented with its associated abbreviated information. For example, given the natural language request “Show me my top five vendors”, the processing service would select among a subset of queries to create a set of candidate results. The set of candidate results could be a plurality of lists, each with the top five names of vendors according to a given criterion (e.g., total spend, air spend, hotel spend, ground spend, and meals spend) for this month, and relevant numeric values (e.g., the amount spent by each vendor). The abbreviated associated information, in this case, could be the names of each vendor and their relevant numerical values. Upon selecting one of the vendors from one of the plurality of lists (e.g., “Courtyard” from “top five total spend”), an expanded view of the candidate result would be shown with more details about the selected result. In this case, the information may be presented as a table with information including name of the vendor, location, department, traveler name, meeting type, year, month, and total spend. The expansion of the candidate result may also include presenting possible follow-up questions with precomputed results that can be selected from to present additional information related to the original

The above approaches are, in some cases, expected to mitigate issues with other techniques. Discussion of such issues here and above should not be read to imply that the features giving rise to those issues are disclaimed or disavowed. Further, discussion of advantages here and above should not be read to imply embodiments are limited to systems exhibiting all of those advantages.

Many approaches to natural language interfaces for data analytics focus on mapping a free-form query directly into a structured query language statement that is executed against a database. These systems often attempt to resolve ambiguity by returning a single interpretation of the user's request, sometimes offering auto-completion or synonym substitution. Such approaches may produce results that are brittle when the input does not exactly match the system's expected phrasing, and they may lack meaningful feedback to the user when the request cannot be resolved. In contrast, some embodiments may operate by selecting from a predefined and verified subset of queries, which reduces the likelihood of generating invalid or misleading queries. By confining the request processing to a curated set of permissible queries, some embodiments may deliver results that are more predictable, verifiable, and aligned with organizational data governance policies.

In addition, many systems attempt to present a single result as the answer to a natural language request. This can give the appearance of certainty even when multiple possible interpretations exist, leaving the user unaware of alternative perspectives or data representations. Some embodiments may instead generate a set of candidate results, each associated with a confidence score, and present multiple abbreviated results ranked by that score. This approach can inform the user of uncertainty, allow comparison across possible interpretations, and even present an empty set when a request falls outside established guardrails. Such features may improve user trust and transparency by acknowledging ambiguity rather than obscuring it.

Another limitation observed in some solutions is that they provide limited mechanisms for enforcing contextual safeguards around data access, compliance, and quality. Some embodiments may employ layered guardrails that extend beyond query syntax checks, including access control guardrails, privacy and compliance guardrails, audit trail guardrails, numeric result guardrails, and user feedback guardrails. These guardrails may prevent inappropriate data exposure, maintain compliance with regulatory standards, and capture user input to improve system performance over time. By incorporating these multiple layers of constraint, some embodiments may provide a controlled and adaptive environment for interacting with data in natural language.

Further, many natural language analytics tools are text-only in both input and output, or at most supplement textual answers with static visualizations. Some embodiments may extend these interactions to include voice-based inputs converted to text for processing, as well as voice-based outputs that provide spoken explanations of candidate results. Other embodiments may generate structured commands such as JSON representations of the selected queries, enabling integration with external systems and downstream automation. Through these additional capabilities, some embodiments may support richer multimodal interactions and tighter coupling with enterprise workflows than approaches that rely solely on text-based question and answer exchanges.

Some embodiments are expected to afford specific technical improvements to specific technical problems. Some embodiments may be directed to specific improvements in how a computer processes natural-language analytics requests, rather than merely computerizing a human analyst's reasoning. In contrast to systems that translate arbitrary text into ad hoc database queries using unconstrained search over a large hypothesis space, certain embodiments may compile a predefined and verified subset of parameterized queries and then select among that subset based on features extracted from the request. Constraining the search space in this way can transform an expensive, nondeterministic synthesis problem into a bounded selection problem with predictable runtime characteristics and lower memory pressure. Because the selected query maps to a verified execution plan, the database engine may avoid repeated parsing and optimization of ill-formed statements, which can reduce CPU cycles and I/O contention and improve cache locality for frequently invoked templates.

Some embodiments may further improve computer operation through a layered guardrail engine integrated at plan selection time. Whereas typical systems detect access or compliance violations after execution or at the presentation layer, the guardrail engine may incorporate access-control checks, numeric range validations, and output-shaping constraints into the query-selection and result-materialization pipeline. By performing these checks before query dispatch, in some embodiments, the system can prevent wasted execution against restricted tables, eliminate expensive scans that would be discarded later, and avoid rendering large payloads that violate output policies. This pre-dispatch enforcement is expected to materially reduce network traffic between tiers, cut down on unnecessary disk reads, and mitigate query storms caused by malformed or overbroad requests.

To address ambiguity without degrading performance, some embodiments may generate multiple candidate results, each with a computed confidence score derived from semantic match features, execution statistics, and validation signals. The system may present abbreviated representations of these candidates instead of fully materializing each visualization. This approach can reduce GPU and CPU load in the rendering subsystem, lower serialization overhead, and shorten time-to-first-byte, while still allowing a user to promote a candidate for full expansion. In cases where guardrails determine that a request is out of bounds, the system may return an explicit boundary indication rather than synthesizing a failing query, thereby avoiding needless database work and error handling in downstream components.

Additional improvements may arise from selective retrieval-augmented generation and structured command emission. Rather than concatenating large volumes of documentation into a model prompt, some embodiments may restrict retrieval to domain- and entity-specific snippets keyed by the verified query template, which can shrink context windows, reduce token processing, and improve determinism of the large-language-model layer. The system may emit a typed JSON command that encodes the selected query and visualization specification, enabling downstream services to execute with fewer schema negotiations and safer deserialization. This structured interface can replace brittle string parsing with schema-validated messages, reducing parse errors and associated retries, and improving overall throughput.

In a multimodal configuration, some embodiments may incorporate a voice interface that performs on-device endpointing and confidence gating before any server-side NLP, dropping low-confidence audio segments locally. By eliminating transmissions of unusable audio and avoiding remote inference for those segments, the system can reduce bandwidth consumption and tail latency while improving reliability under poor network conditions.

Certain terms in this application are best understood with reference to examples of their referents. In some embodiments, a natural language request may be received as text, speech converted to text, or a combination of linguistic tokens with structured hints, and may include partial utterances, disfluencies, or multimodal context such as a selected chart region. Certain embodiments may process requests within constrained grammars or domain lexicons as well as free-form prose, and may treat successive follow-ups as part of the same request context.

In some embodiments, the subset of queries may comprise parameterized templates, dynamically activated or deactivated according to context, permissions, or data freshness, and may be expanded over time based on governance workflows. The subset may be generated or curated programmatically and need not be exhaustively enumerated at deployment time.

In some embodiments, candidate results may include heterogeneous outputs such as tables, charts, textual summaries, statistical aggregates, and links to underlying records, and may include an explicit empty-set candidate communicating that the request is out of bounds. Candidate results may be derived from multiple semantically equivalent interpretations of the request and may be tagged for provenance, data coverage, or visualization type.

In some embodiments, a confidence score may be computed from a combination of semantic match features, rule-based validations, historical engagement signals, and execution statistics, and may govern ranking, truncation, or conditional expansion of results. The score may be normalized or unnormalized and need not represent a calibrated probability

In some embodiments, guardrails may be implemented across layers, including pre-dispatch access checks, query-shape constraints, numeric range validations, privacy transformations, output-size controls, audit logging, and user feedback capture. Guardrails may be enforced synchronously during plan selection or asynchronously via policy engines, and may be updated without redeploying the analytics engine.

In some embodiments, a boundary violation may be manifested as an explicit message, an empty candidate set, disabled UI affordances, or proactive suggestions that steer a user back to supported intents, and may be triggered by policy, capability limits, or detected ambiguity that cannot be resolved within constraints.

In some embodiments, abbreviated information may include visual thumbnails, textual key-value highlights, confidence badges, compact statistical descriptors, or short audio snippets that summarize a candidate without fully rendering it. Abbreviated information may adapt to device constraints or bandwidth budgets.

In some embodiments, a visual data representation may encompass static or interactive charts, pivot tables, geospatial maps, network graphs, or annotated dashboards, and may include tooltips, drill-down affordances, and responsive layouts. Visual data representations may be generated server-side or client-side and may be previewed in reduced fidelity.

In some embodiments, predefined and verified queries may be expressed as templates compiled into execution plans, with verification performed via automated tests, schema checks, or policy validation, and may be re-verified as schemas or policies evolve. Verification may be continuous and machine-assisted rather than solely manual.

In some embodiments, a voice over explanation may include synthesized speech that summarizes the rationale for ranking, highlights key metrics from a candidate, or narrates a visualization, and may operate on-device or via a service. The audio output may be selective, concise, and context-aware rather than a verbatim reading of full results.

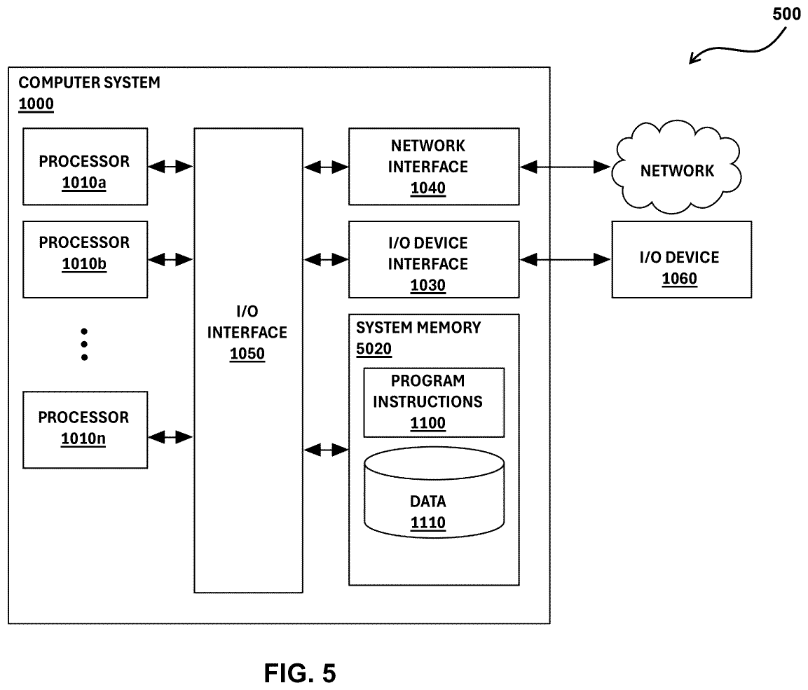

FIG. 5 is a diagram that illustrates an exemplary computing system 1000 in accordance with embodiments of the present technique. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface May 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood when read in reference to the following enumerated embodiments:

1. A method for handling natural language ambiguity, comprising: receiving, with a computer system, a natural language request that relates to data in a data store; selecting, with the computer system, among a subset of queries in a query language based on the natural language request; creating, with the computer system, a set of candidate results in response to the natural language request; determining, with the computer system, a confidence score for the set of candidate results; and presenting, with the computer system, at least some candidate results and their associated abbreviated information, based on the confidence score of each result.

2. The method of embodiment 1, wherein a natural language request is received through a user interface.

3. The method of embodiment 1, wherein a natural language request is a voice input converted to text with a speech-to-text model.

4. The method of embodiment 1, comprising transforming a response to the user's request into a visual data representation.

5. The method of embodiment 1, wherein the queries, from which the subset of queries is selected, are predefined and verified.

6. The method of embodiment 1, wherein selecting among a subset of queries comprises: determining whether the request is within a known dictionary of interrogations using guardrails; parsing the natural language request; and precomputing a second set of candidate results to anticipate follow-up questions.

7. The method of embodiment 6, wherein the guardrails determine when the information requested cannot be fulfilled by available data or computational capabilities and present the user with a boundary violation if an out-of-bound natural language request is made.

8. The method of embodiment 6, wherein the guardrails implemented include at least three of the following: Access Control Guardrails, Query Guardrails, Output Control Guardrails, Privacy and Compliance Guardrails, Audit Trail Guardrails, Numeric Result Guardrails, and User Feedback Guardrails.

9. The method of embodiment 6, wherein the guardrails implemented include all of the following: Access Control Guardrails, Query Guardrails, Output Control Guardrails, Privacy and Compliance Guardrails, Audit Trail Guardrails, Numeric Result Guardrails, and User Feedback Guardrails.

10. The method of embodiment 6, wherein parsing the natural language request comprises extracting features to determine the appropriate type of visualization.

11. The method of embodiment 1, wherein retrieval-augmented generation (RAG) is used for dynamically fetching relevant documentation to allow a large language model (LLM) to contextually constrain domain- and entity-specific knowledge to fit in the LLM prompt.

12. The method of embodiment 11, further comprising fine tuning the LLM, wherein fine tuning comprises training a foundational LLM on a dataset that contains natural language requests and corresponding data visualization specifications.

13. The method of embodiment 6, wherein the precomputed results are based on available data dimensions and are redefined over time using user behavior to suggest additional insights to complement the original natural language request.

14. The method of embodiment 1, wherein the candidate results are created by providing a plurality of semantically equivalent questions to match a natural language request and tagging the various types of candidate results with keywords.

15. The method of embodiment 1, wherein the set of candidate results is a single result that is presented as the answer.

16. The method of embodiment 1, wherein the set of candidate results include a plurality of results that are all presented in abbreviated form, each result selected by their ranked confidence score.

17. The method of embodiment 1, wherein the set of candidate results is an empty set corresponding to an out-of-bound request determined by the guardrails.

18. The method of embodiment 1, wherein the confidence score is used to determine how the result is presented and in which order the results are listed.

19. The method of embodiment 1, wherein the data store is a structured data store.

20. The method of embodiment 1, wherein presenting at least some candidate results and their associated abbreviated information further comprises providing a voice over explanation of at least one of the candidate results.

21. The method of embodiment 1, wherein selecting among the subset of queries further comprises generating a JavaScript Object Notation (JSON) command based on the selected query and wherein creating the set of candidate results comprises creating the set of candidate results based on the generated JSON command.

22. A computer readable medium storing instructions that, when executed by a computer system, effectuate the operations of any of embodiments 1-21.

23. A computer system comprising one or more processors and memory storing instructions that, when executed by the one or more processors, effectuate the operations of any of embodiments 1-21.

What is claimed is:

1. A method for handling natural language ambiguity, comprising:
receiving, with a computer system, a natural language request that relates to data in a data store;
selecting, with the computer system, among a subset of queries in a query language based on the natural language request;
creating, with the computer system, a set of candidate results in response to the natural language request;
determining, with the computer system, a confidence score for the set of candidate results; and
presenting, with the computer system, at least some candidate results and their associated abbreviated information, based on the confidence score of each result.

2. The method of claim 1, wherein a natural language request is received through a user interface.

3. The method of claim 1, wherein a natural language request is a voice input converted to text with a speech-to-text model.

4. The method of claim 1, comprising transforming a response to the user's request into a visual data representation.

5. The method of claim 1, wherein the queries, from which the subset of queries is selected, are predefined and verified.

6. The method of claim 1, wherein selecting among a subset of queries comprises:
determining whether the request is within a known dictionary of interrogations using guardrails;
parsing the natural language request; and
precomputing a second set of candidate results to anticipate follow-up questions.

7. The method of claim 6, wherein the guardrails determine when the information requested cannot be fulfilled by available data or computational capabilities and present the user with a boundary violation if an out-of-bound natural language request is made.

8. The method of claim 6, wherein the guardrails implemented include at least 3 of the following: Access Control Guardrails, Query Guardrails, Output Control Guardrails, Privacy and Compliance Guardrails, Audit Trail Guardrails, Numeric Result Guardrails, and User Feedback Guardrails.

9. The method of claim 6, wherein the guardrails implemented include all of the following: Access Control Guardrails, Query Guardrails, Output Control Guardrails, Privacy and Compliance Guardrails, Audit Trail Guardrails, Numeric Result Guardrails, and User Feedback Guardrails.

10. The method of claim 6, wherein parsing the natural language request comprises extracting features to determine the appropriate type of visualization.

11. The method of claim 1, wherein retrieval-augmented generation (RAG) is used for dynamically fetching relevant documentation to allow a large language model (LLM) to contextually constrain domain- and entity-specific knowledge to fit in the LLM prompt.

12. The method of claim 11, further comprising fine tuning the LLM wherein fine tuning comprises training a foundational LLM on a dataset that contains natural language requests and corresponding data visualization specifications.

13. The method of claim 6, wherein the precomputed results are based on available data dimensions and are redefined over time using user behavior to suggest additional insights to complement the original natural language request.

14. The method of claim 1, wherein the candidate results are created by providing a plurality of semantically equivalent questions to match a natural language request and tagging the various types of candidate results with keywords.

15. The method of claim 1, wherein the set of candidate results is a single result that is presented as the answer.

16. The method of claim 1, wherein the set of candidate results include a plurality of results that are all presented in abbreviated form, each result selected by their ranked confidence score.

17. The method of claim 1, wherein the set of candidate results is an empty set corresponding to an out-of-bound request determined by the guardrails.

18. The method of claim 1, wherein the confidence score is used to determine how the result is presented and in which order the results are listed.

19. The method of claim 1, wherein the data store is a structured data store.

20. The method of claim 1, wherein presenting at least some candidate results and their associated abbreviated information further comprises providing a voice over explanation of at least one of the candidate results.

21. The method of claim 1, wherein selecting among the subset of queries further comprises generating a JavaScript Object Notation (JSON) command based on the selected query and wherein creating the set of candidate results comprises creating the set of candidate results based on the generated JSON command.

22. A tangible, non-transitory, machine-readable medium storing instructions that when executed by one or more processors effectuate operations comprising:
receiving, with a computer system, a natural language request that relates to data in a data store;
selecting, with the computer system, among a subset of queries in a query language based on the natural language request;
creating, with the computer system, a set of candidate results in response to the natural language request;
determining, with the computer system, a confidence score for the set of candidate results; and
presenting, with the computer system, at least some candidate results and their associated abbreviated information, based on the confidence score of each result.
